(19) United States
(12) Patent Application Publication
(10) Pub. No.: US 2011/0162218 A1
(43) Pub. Date: Jul. 7, 2011

(54) HAND HELD CIRCULAR SAW POWER TOOL HAVING MULTIPLE MODES OF OPERATION

(76) Inventors: Andrew Roise, (US); Keith Park, (US)

(21) Appl. No.: 12/982,967

(22) Filed: Dec. 31, 2010

(30) Foreign Application Priority Data
Jan. 4, 2010 (CN) 201010017253.1

(51) Int. Cl. B23D 45/16

(52) U.S. Cl. 30/377

(57) ABSTRACT

The present application relates to a circular saw power tool having a housing, a motor in the housing, a circular saw blade driven to rotate by the motor, and a base plate that supports the housing and contacts the surface of the workpiece to be cut. The housing is connected pivotably to the base plate around a pivotal axis that is parallel to the rotation axis, and the base plate has a slot for the circular saw blade to extend below the base plate. The power tool has a first cutting mode that provides cutting for a predetermined depth and a second cutting mode that provides vertical cutting in a limited area, as well as a switching device for switching between the first and second cutting modes. As a result, the present application is able to integrate two different cutting functions into a single power tool to increase work efficiency.

### CROSS-REFERENCE TO RELATED APPLICATIONS

This application claims priority to CN 201010017253.1, filed Jan. 4, 2010, which is hereby incorporated by reference.

### FEDERALLY SPONSORED RESEARCH OR DEVELOPMENT

Not Applicable.

### TECHNICAL FIELD

The invention relates to a power tool, more particularly to a hand-held power tool having a circular saw blade.

### BACKGROUND OF THE INVENTION

A hand-held electric circular saw according to the disclosures of the prior art usually had a rotatable protection guard, a circular saw blade, an adjustment mechanism for cutting depth and an adjustment mechanism for cutting angle. The cutting depth of the circular saw refers to the distance that the circular saw blade protrudes to below the base plate of the electric circular saw. The circular saw blade can pivot up and down with respect to the base plate of the electric circular saw around an axis parallel to the rotation axis, and can be locked at a predetermined position with respect to the base plate by means of a clamp device. The hand-held electric circular saw is usually supported by the base plate that works on the workpiece directly, so as to facilitate controlling of the vertical and inclined positions of the circular saw blade with respect to the workpieces by users.

The prior hand-held electric circular saw with a protection guard was primarily used for push-type cutting, and rarely used for insert-type cutting. A circular saw without the protection guard is better designed for insert-type cutting. Such a circular saw that can implement the insert-type cutting has a saw blade that may pivot up and down in unison with the housing of the motor or the gearbox with respect to the base plate so as to adjust the cutting depth. To help with safety, the saw blade of such an insert-type circular saw cannot be locked at a predetermined position with respect to the base plate. However, the movement may be limited to a specific area by a backstop. Likewise for other safety reasons, a spring-like device may be mounted into the insert-type circular saw for pressing the blade into the position of the minimal cutting depth, instead of the protection guard. A circular saw with this structure for implementing the insert-type cutting does not require the clamp device for controlling the cutting depth of the prior art implementations which would make the saw unsuitable for push-type cutting operations.

### SUMMARY OF THE INVENTION

The object of the present application is to provide a power tool that can implement both push-type cutting and insert-type cutting methods. To achieve this objective, the power tool of the present application has a housing, a motor in the housing, a circular saw blade driven to rotate by the motor about a rotation axis, and a base plate that supports the housing and is positioned on the surface of the workpiece to be cut. The housing may be connected to the base plate pivotably around a pivotal axis that is parallel to the rotation axis. The base plate may have an elongated slot for the circular saw blade to protrude below the base plate. Such a power tool may have a first cutting mode that may perform a cutting operation to a first predetermined depth and a second cutting mode that may allow for vertical cutting in a limited area.

The above described power tool may also have a switching device for switching between the first cutting mode and the second cutting mode. As a result, the power tool disclosed in the present application lends itself to both a push-type cutting function and an insert-type cutting function using the switching device to switch between the first cutting mode and the second cutting mode. As a result of the two modes of operation, operating efficiency is enhanced by integrating two functions that are normally implemented by two different power tools into one power tool.

### BRIEF DESCRIPTION OF THE DRAWINGS

To understand the present application, it will now be described by way of example, with reference to the accompanying drawings in which:

FIG. 1 is a perspective view of the power tool according to a first embodiment of the present application;

FIG. 2 is a perspective view of the power tool of FIG. 1 with the primary handle portion removed;

FIG. 3 is a side view of the power tool of FIG. 1 arranged for the deepest cutting depth;

FIG. 4 is a side view of the power tool of FIG. 1 arranged for the shallowest cutting depth;

FIG. 5 is a perspective view of the power tool of FIG. 1 with the primary handle and the base plate removed;

FIG. 6 is a perspective view of the base plate and the depth guide bracket of the power tool according to the present application;

FIG. 7A is a perspective view illustrating the insert-type cutting arrangement of FIG. 1 with the first clutch disc and the second clutch disc detached from each other;

FIG. 7B is a top plan view of the insert-type cutting arrangement of FIG. 7A;

FIG. 7C is a cross sectional view of the insert-type cutting arrangement taken along the line C-C in FIG. 7B;

FIG. 8 is a perspective view of the power tool of FIG. 1 with an exploded view of the insert-type cutting arrangement;

FIG. 9 is a perspective view of the power tool of FIG. 1 with another exploded view of the insert-type cutting arrangement;

FIG. 10 is a perspective view of the power tool of FIG. 1 arranged to cut obliquely in the push-type cutting mode;

FIG. 11A is an exploded view of the insert-type cutting arrangement according to another embodiment of the present application;

FIG. 11B is a side view of the insert-type cutting arrangement of FIG. 11A;

FIG. 11C is a sectional view taken along the direction A-A in FIG. 11B;

FIG. 12 is a side view illustrating the power tool according to the first embodiment of FIG. 1, wherein the lower guard may be opened automatically;

FIG. 13 is a side view illustrating the power tool according to the first embodiment of FIG. 1, wherein the primary handle has a first handling position and a second handling position;

FIG. 14A is a bottom view illustrating the power tool according to the first embodiment in FIG. 1, wherein the base plate has a guide groove and roller device; and,

FIG. 14B is a side view illustrating the power tool according to the first embodiment in FIG. 1, wherein the base plate has a guide groove and roller device.

### DETAILED DESCRIPTION

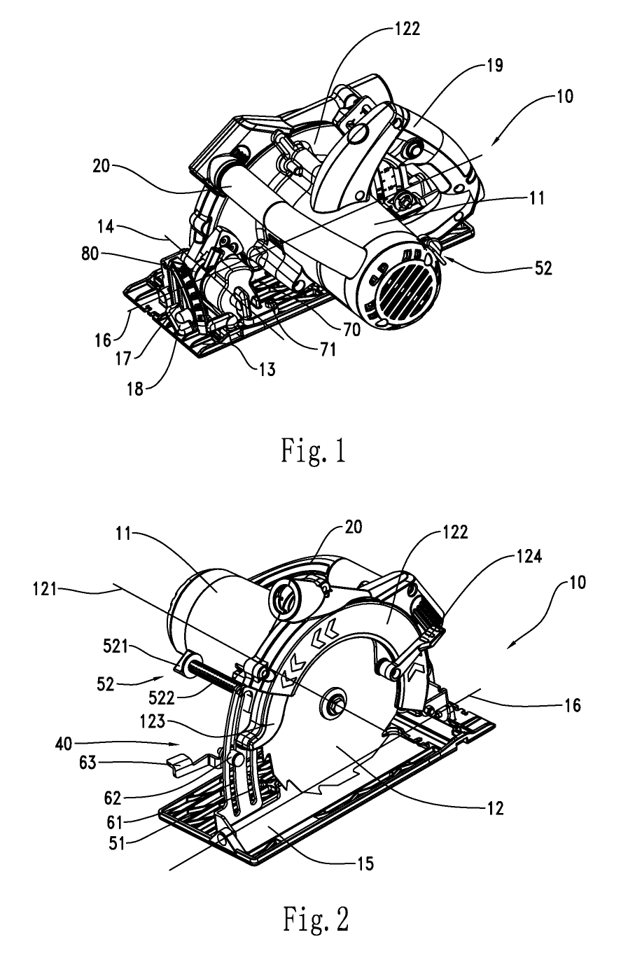

FIGS. 1 and 2 illustrate a power tool 10 according to a first embodiment of the present application, which has a housing 11, a motor (not shown) in the housing 11 and a circular saw blade 12 driven to rotate by the motor. The circular saw blade 12 has a rotation axis 121 around which it can rotate. The circular saw blade 12 is covered in its upper portion by a stationary guard 122 and in its lower portion by a rotatable lower guard 123. An operating rod 124 is provided for moving the lower guard 123 between a position at which the circular saw blade 12 is exposed and a position at which the circular saw blade 12 is covered. The power tool 10 also comprises a base plate 13 which supports the housing 11 mounted thereon and contacts the surface of the workpiece to be cut. The housing 11 is pivotably coupled to the base plate 13 and may pivot upward and downward around an axis 14 that is parallel to the rotation axis 121. The base plate 13 is provided with an elongated slot 15, through which the circular saw blade 12 may protrude below the base plate 13. The housing 11 may also pivot obliquely right and left around an axis 16 that is perpendicular to the rotation axis 121. The angle that the housing 11 pivots with respect to the base plate 13 may be determined by an angle bracket 17 having a scale indication. After the housing 11 pivots into the predetermined angle position, a knob 18 is used to fix the housing 11 in the predetermined angle position for implementing the cutting at an inclined angle. Hand-held electric circular saws in the prior art usually have such a function of inclined cutting. The structures for achieving this function are also well known for the persons skilled in the art. Therefore details are not described herein. The power tool 10 also comprises a primary handle 19 and a secondary handle 20 for holding by the users.

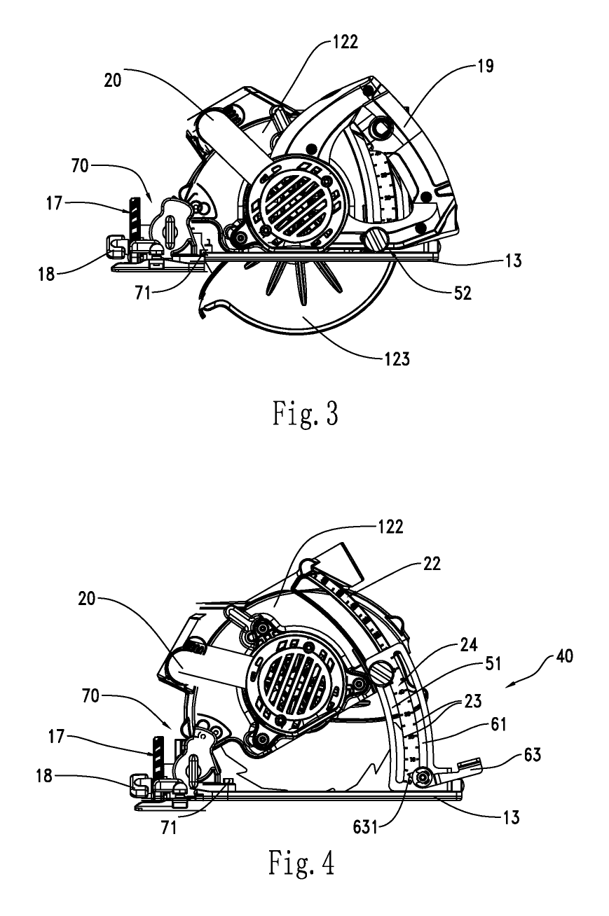

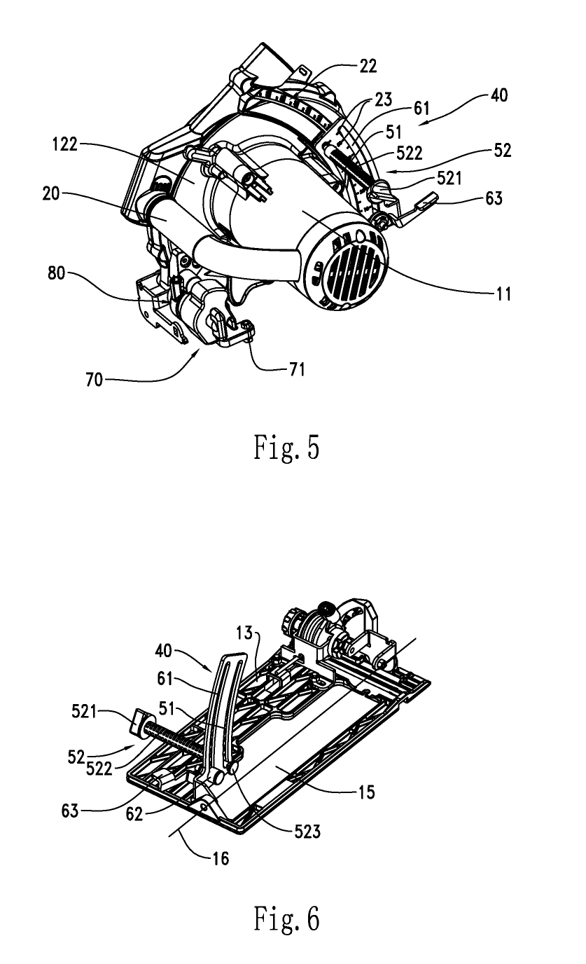

Referring to FIGS. 3-6, the power tool 10 also comprises a depth guide bracket 40 which is mounted pivotally on the base plate 13 and may pivot obliquely left and right together with the housing 11 around the axis 16. The depth guide bracket 40 has a first elongated track 51 and a second elongated track 61 thereon. The first track 51 and the second track 61 constitute parts of two circles and have a common center. A clamp device 52 is connected through the primary handle 19 to the stationary guard 122 located on one side of the motor. However, in the other embodiments, the clamp device 52 may also be directly connected to the stationary guard located on one side of the motor. The clamp device 52 comprises a knob 521 and a bolt 522 partly positioned in the first track 51. The bolt 522 is connected to the knob 521 at one end thereof and has a head 523 connected fixedly to the stationary guard 122 at the other end. When the stationary guard 122 together with the handle 19 pivots upward around the axis 14, the portion of the bolt 522 in the first track 51 slides in the first track 51 correspondingly. The clamp device 52 and the depth guide bracket 40 comprising the first track 51 commonly form an adjustment mechanism for the cutting depth, which may lock the housing 11 in the position of a predetermined cutting depth with respect to the base plate 13, so that a push-type cutting in this depth position may be implemented. The stationary guard 122 located on one side of the motor is marked with a cutting depth scale 22. The setting of the cutting depth may be accomplished by aligning the mark 23 located on the depth guide bracket 40 with the exact value located on the cutting depth scale 22. The steps of setting the cutting depth are as follows: Firstly, rotating the knob 521 to unlock the housing 11 from the depth guide bracket 40, and then operating the primary handle 19 to pivot the housing 11 up and down around the axis 14, and the portion of the bolt 522 in the first track 51 slides in and along the first track 51. Then, while observing the scale, rotating the knob 521 in the reverse direction to fixedly lock the housing 11 on the depth guide bracket 40 when the housing 11 pivots into the position of a desired cutting depth, so that the housing 11 is fixed at the position of the desired cutting depth with respect to the base plate 13. The well-known hand-held electric circular saws with protection guards usually have such an adjustment mechanism for the cutting depth and their constructions are well known to the persons skilled in the art, thereby details are not described herein. FIG. 3 illustrates the side view of the power tool in the state of the largest cutting depth. FIG. 4 illustrates the side view of the power tool in the state of the smallest cutting depth.

Compared with the well-known hand-held electric circular saw with a protection guard, the power tool 10 also comprises a second track 61 likewise on the depth guide bracket 40 and a backstop 62 slidable in the second track 61. The backstop may be comprised of a bolt. An operating handle 63 is connected to the backstop 62. The depth guide bracket 40 comprising the second track 61, and the backstop 62 as well as the operating handle 63 together constitute an adjustment mechanism for the depth of the backstop, which allows the housing 11 to pivot up and down in a limited depth area with respect to the base plate 13, so as to implement the insert-type cutting. The depth guide bracket 40 is also marked with depth indicating scale 24. The setting of the depth of the backstop is accomplished by aligning the indicator 631 attached to the backstop 63 with the value on the depth indicating scale 24. The steps of setting the depth of the backstop are as follows: rotating the operating handle 63 to unlock the backstop 62 from the second track 61; sliding the backstop 62 to the desired depth position along the second track 61; and, rotating the operating handle 63 in the reverse direction to lock the backstop 62 in the second track 61. After following these steps, the power tool 10 is in such a state that it may implement the insert-type cutting, the power tool 10 may implement vertical insert-type cutting in the depth area.

Persons skilled in the art may easily envisage that a depth guide bracket comprising only one track may implement both the push-type cutting and the vertical insert-type cutting functions, instead of the above depth guide bracket 40 comprising the first track 51 and the second track 61 simultaneously. For example, the second track 61 may be removed and the backstop 62 may be arranged slideably in the first track 51. When a push-type cutting is needed to be implemented, the backstop 62 is positioned into the lowest position of the first track 51, and then the clamp device 52 which is also positioned in the first track 51 is used to fix the housing 11 at a position of the desired cutting depth with respect to the base plate 13 to implement the push-type cutting. When an insert-type cutting is needed, the clamp device 52 is used to unlock the housing 11 from the base plate 13, and the operating handle 63 is used to lock the backstop 62 at the position of a desired depth in the first track 51, so as to allow the insert-type cutting function.

The power tool 10 also comprises an insert-type cutting device 70 which enables the circular saw blade 12 to cut vertically in a limited depth area and is fixed to the base plate 13 by a bolt 71. A clutch device 80 is coupled between the housing 11 and the insert-type cutting device 70, by which the insert-type cutting device 70 can be connected to or disconnected from the housing 11 so as to accomplish the switching between the above insert-type cutting mode and the push-type cutting mode.

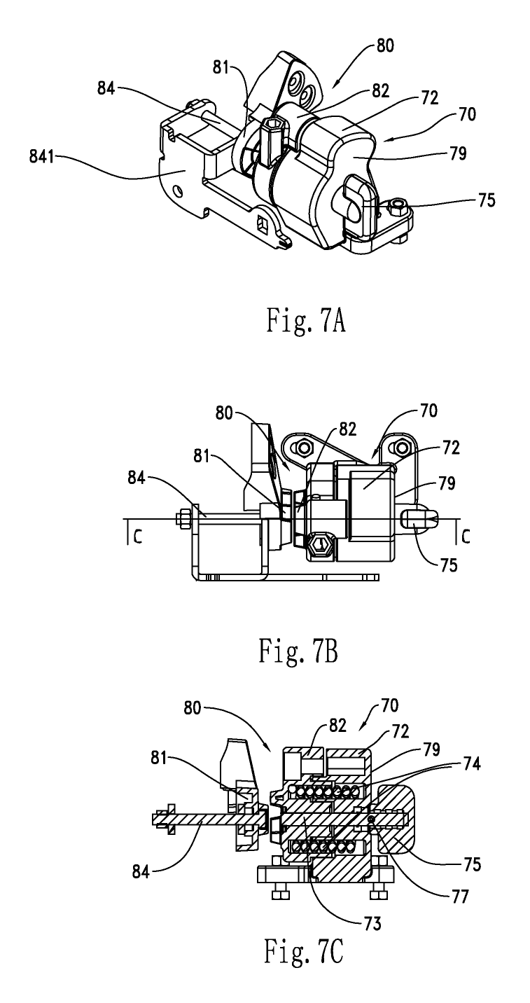

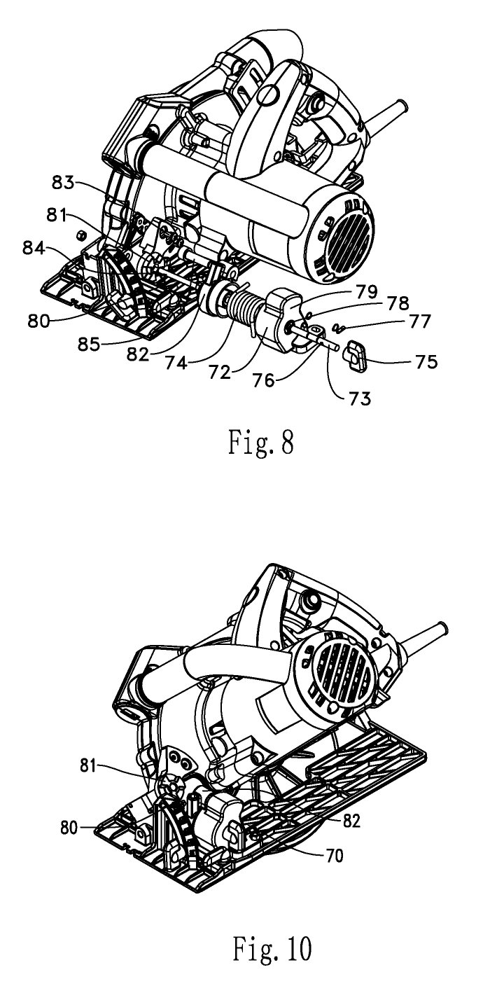

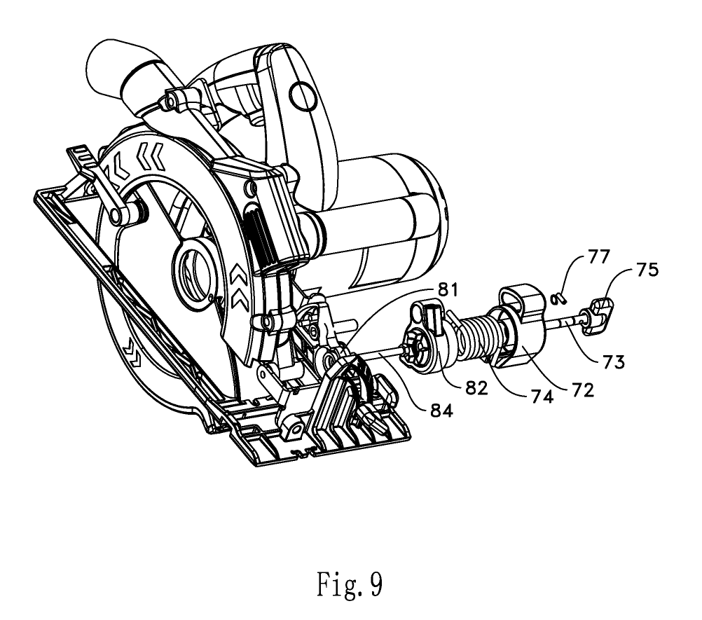

Now referring to FIGS. 7-9, the clutch device 80 comprises a first clutch disc 81 and a second clutch disc 82. The first clutch disc 81 is connected to the housing 11 by a screw 83 and a pivotal shaft 84 that is inserted and connected to the pivotal support 841 mounted on the base plate. In other embodiments, the first clutch disc 81 may also be formed on the housing 11 directly, while the second clutch disc 82 is connected to the insert-type cutting device 70. The insert-type cutting device 70 comprises an outer housing 72 connected adjacent to the second clutch disc 82, a shaft 73 for connecting the second clutch disc 82 and the outer housing 72 together in series, and a spring 74 located in the second clutch disc 82 and the outer housing 72. The second clutch disc 82 is connected to the outer housing 72 by the connecting rod 85 thereon for limiting the position of the spring 74. One end of the shaft 73 away from the second clutch disc 82 protrudes out of the outer housing 72 with a knob 75 mounted on said end. Beside the knob 75, a through hole 76 is formed on the shaft 73, and a locking pin 77 is fixedly inserted into the through hole 76 with two ends protruding out of the through hole 76.

In order to implement the insert-type cutting, the insert-type cutting device 70 needs to be connected to the housing 11. Firstly, the power tool 10 shall be moved into the position of the minimal cutting depth as shown in FIG. 4, where the first clutch disc 81 and the second clutch disc 82 may be mated and aligned with each other. After the first clutch disc 81 and the second clutch disc 82 are mated and aligned with each other, the knob 75 is rotated to enable the locking pin 77 to be aligned with the elongated slot 78 located on the housing 72 of the insert-type cutting device. The knob 75 is pushed left to enable the locking pin 77 to pass through the elongated slot 78. Finally, the knob 75 is rotated 90 degrees to lock the insert-type cutting device 70 and the first clutch disc 81 together. Since the first clutch disc 81 and the housing 11 are fixedly connected, the insert-type cutting device 70 is fixedly connected to the housing 11. When the insert-type cutting device 70 is connected to the housing 11 by the first clutch disc 81 and the second clutch disc 82, the power tool 10 is switched into the insert-type cutting mode, where the users may implement an inset-type cutting. In this insert-type cutting mode, the insert-type cutting device 70 is connected to the housing 11, so the spring force of spring 74 in the insert-type cutting device 70 acts on the housing 11. When a user presses the power tool 10 down against the spring force of the spring 74, the saw blade 12 is inserted into the workpiece to be cut. Correspondingly the first clutch disc 81 pivots down about the pivotal shaft 84 and drives the second clutch disc 82 engaged together with itself to rotate in clockwise direction, while the housing 72 of the insert-type cutting device 70 is stationary. When the power tool 10 is moved down and comes into contact with the backstop 62, the user stops applying the force downwardly. The power tool 10 is restored back to the position of the initial cutting depth automatically by the spring 74 arranged in the second clutch disc 82 and the insert-type cutting device 70. In this embodiment, the position of the initial cutting depth is the position of the minimal cutting depth as shown in FIG. 4. After setting a position of the backstop depth by the above adjustment mechanism for the backstop depth, a user may implement the vertical insert-type cutting repeatedly in the depth area between the position of the minimal cutting depth and the backstop 62. Persons skilled in the art may easily envisage that the first clutch disc 81 and the second clutch disc 82 may be engaged and aligned with each other in other selected positions without limitation to the position of the minimal cutting depth, such as the position of the deepest cutting depth as shown in FIG. 3 or other positions between the deepest cutting depth position and the minimal cutting depth position.

By reversing the above steps of locking, the insert-type cutting device 70 may be disconnected from the housing 11. Firstly, the knob 75 is rotated by 90 degrees to enable the alignment of the locking pin 77 with the elongated slot 78, and the knob 75 is pulled rightward to drive the shaft 73 to move rightward correspondingly and further to drive the locking pin 77 out of the elongated slot 78. Then the acting force applied on the first clutch disc 81 and the second clutch disc 82 disappears, so the first clutch disc 81 and the second clutch disc 82 are disengaged so as to disconnect the insert-type cutting device 70 from the housing 11. When the insert-type cutting device 70 and the housing 11 are in the disconnected state, the knob 75 is rotated so that the locking pin 77 is not aligned with the slot 78 but abuts against the outer end surface 79 of the housing 72 of the insert-type cutting device 70, so as to effectively prevent the accidental engagement of the first clutch disc 81 and the second clutch disc 82.

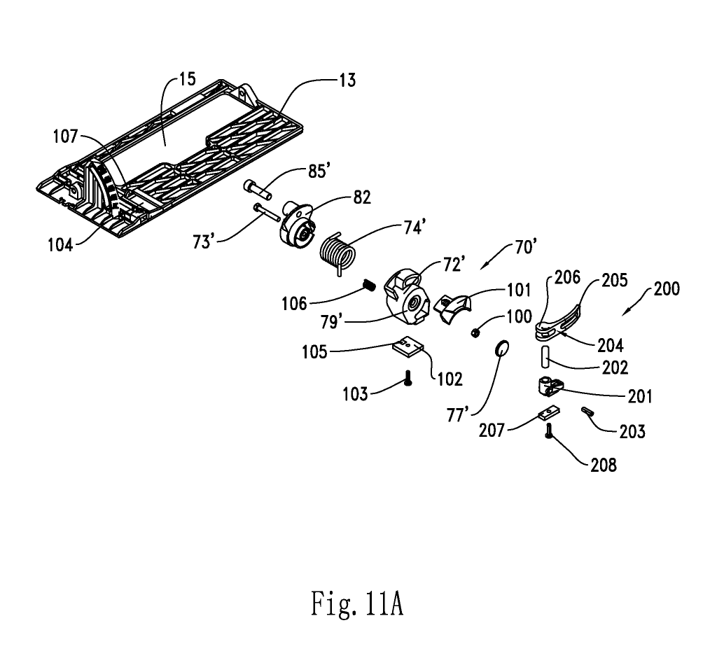

When the insert-type cutting device 70 is disconnected from the housing 11, the power tool 10 is switched into the push-type cutting mode, in which the spring force of the spring 74 doesn't act on the housing 11. After setting a position of a certain cutting depth by means of the above adjustment mechanism for cutting depth, a user could implement the push-type cutting in this cutting depth. In this invention, the above inclined cutting function could only be implemented in the push-type cutting mode. Specifically, the insert-type cutting device 70 is disconnected from the housing 11 so that a gap is generated around the first clutch disc 81 (see FIG. 10). After the knob 18 is unlocked and the power tool 10 is pivoted to a predetermined angle position, the knob 18 is locked so as to fix the power tool 10 at the predetermined angle position for implementation of the inclined cutting.

In the present application, the stationary guard 122 covering the upper portion of the circular saw blade 12 may be directly formed on the housing 11 or as a part of the housing 11. It may also be fixedly connected to the housing 11 as a separate member. When the stationary guard 122 covers the upper portion of the circular saw blade 12 as a separate member, the insert-type cutting device 70 is fixedly connected to the stationary guard 122 by the clutch device 80.

Persons skilled in the art may also envisage that the insert-type cutting device 70 may be not limited to be mounted on the base plate 13, either. The insert-type cutting device 70 and the second clutch disc 82 may be mounted or directly formed on the housing 11, and the first clutch disc 81 may be fixedly mounted on the base plate 13, such that the power tool will be switched into the insert-type cutting mode after the first clutch disc 81 and the second clutch disc 82 are aligned with each other and locked together.

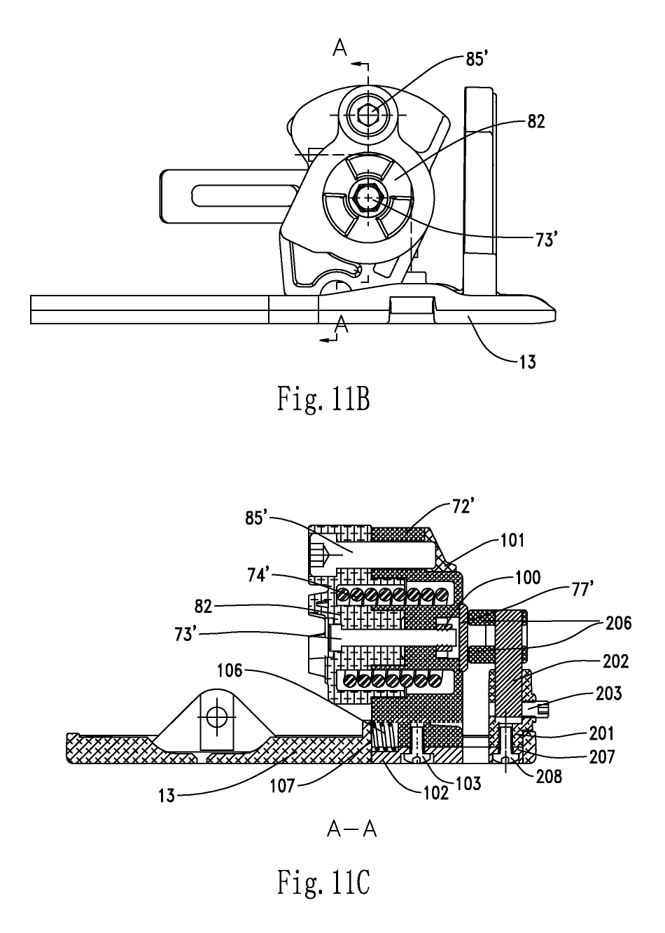

FIGS. 11A-C illustrate another embodiment of the insert-type cutting device according to the present application. This insert-type cutting device 70′ comprises an outer housing 72′ which may be connected adjacent to the second clutch disc 82, a bolt 73′ and a nut 100 for fixedly connecting the second clutch disc 82 and the outer housing 72′ together, and a spring 74′ located in the second clutch disc 82 and the outer housing 72′. A backstop bolt 85′ may be mounted through the second clutch disc 82 and the outer housing 72′ on the indicator panel 101 for limiting the positions of the spring 74′. The base plate 13 comprises an elongated slot 104 in which the insert-type cutting device 70′ may be mounted. After the insert-type cutting device 70′ may be disposed into the slot 104 from above of the base plate 13 and a base cover 102 may be fixed from below the base plate 13 to the lower portion of the insert-type cutting device 70′ by a screw 103, the two long sides of the elongated slot 104 in the direction perpendicular to the saw blade are just clamped in the gap formed between the base guard 102 and the insert-type cutting device 70′, such that the insert-type cutting device 70′ may be mounted on the base plate 13. The insert-type cutting device 70′ may be limited for the displacement in the direction perpendicular to the bottom plate 13, but it may still displace in the direction parallel to the two long sides of the elongated slot 104. A groove 105 may be formed between the lower end of the insert-type cutting device 70′ and the base cover 102, and a spring 106 may be placed between the groove 105 and the projection 107 on the base plate 13. A screw cap 77′ may be mounted on the end surface 79′ of the insert-type cutting device 70′. For cooperation with the insert-type cutting device 70′, a pressing device 200 may be also provided in this embodiment for pressing the first clutch disc 81 and the second clutch disc 82 which are aligned with each other together. The pressing device 200 comprises a locking support 201, a locking pin 202 inserted into the locking support 201, a locking screw 203 through the locking support 201 for pressing the locking pin 202, and a locking handle 204 mounted on the locking pin 202 and rotatable around the locking pin 202. One end 205 of the locking handle 204 may be operated directly by the hands of the users, and the other end 206 has a cam surface in contact with the screw cap 77′ mounted on the end surface 79′ of the insert-type cutting device 70′. The pressing device 200 may be mounted into the elongated slot 104 from above the base plate 13, and then a locking support cover 207 may be fixed from below the base plate 13 on the lower surface of the pressing device 200 by a screw 208, such that the pressing device 200 may be fixedly mounted into the slot 104 of the base plate 13. The locking handle 204 may be rotated by its one end 205. When the cam surface of a larger radius of the other end 206 comes into contact with the screw cap 77′, the second clutch disc 82 and the insert-type cutting device 70′ are moved together towards the first clutch disc 81. The second clutch disc 82 and the first clutch disc 81 are pressed and connected together so as to fixedly connect the insert-type cutting device 70′ onto the housing. When the cam surface of a smaller radius of the other end 26 comes into contact with the screw cap 77′, the spring force of the spring 106 forces the second clutch disc 82 and the insert-type cutting device 70′ to move together in the direction away from the first clutch disc 81. The first clutch disc 81 and the second clutch disc 82 are separated so as to disconnect the insert-type cutting device 70′ from the housing. By means of such a locking handle 204 having cam surfaces, the connection or the disconnection between the insert-type cutting device and the power tool can be accomplished quickly. The operation is more comfortable and convenient in comparison with the above method of knob locking.

A person skilled in the art may also envisage some other locking devices to accomplish the connection or the disconnection of the insert-type cutting device to or from the housing. Moreover, the locking device is not limited to the mechanical structures, and may also be some other devices achieving the locking function by magnetic force.

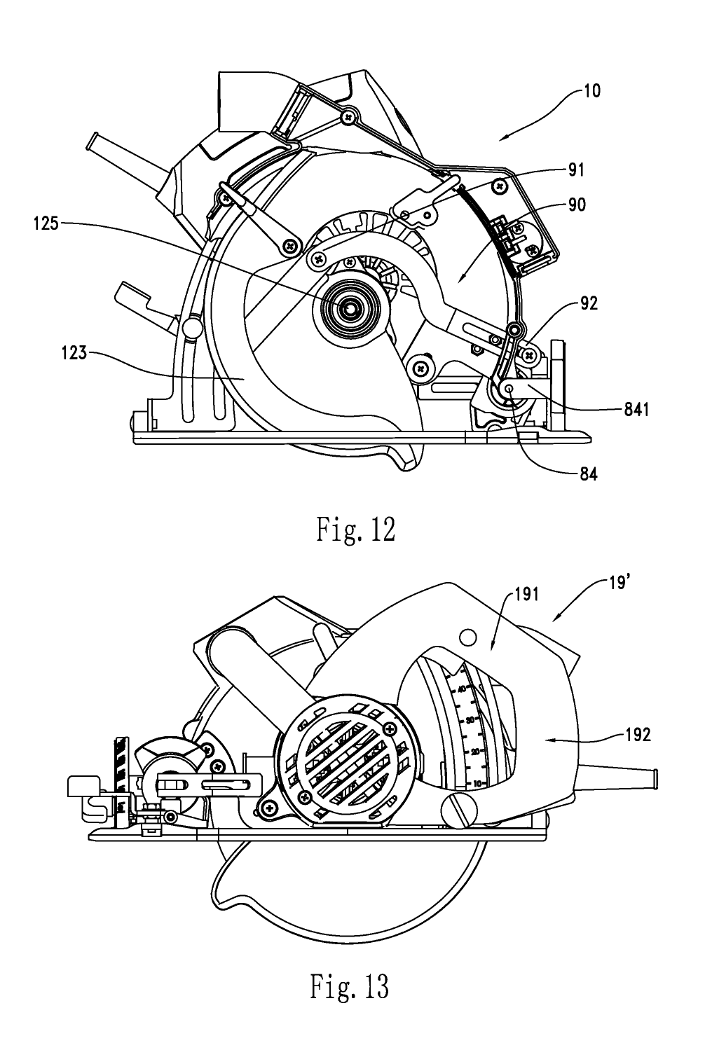

Referring to FIG. 12, the power tool 10 in the above embodiments may also be added with a linkage mechanism 90 for automatically opening the lower guard 123 in the insert-type cutting mode. The lower guard 123 may be pivotably mounted on the shaft 125 of the saw blade 12. One end 91 of the linkage mechanism 90 may be connected to the lower guard 123, and the other end 92 may be connected to the pivotal support 841. When the housing 11 and the circular saw blade 12 pivot downward around the pivotal shaft 84 together, the lower guard 123 may be pulled to rotate in the contrary direction by the linkage mechanism 90, so as to accomplish the automatic opening of the lower guard 123. Preferably, persons skilled in the art may also envisage that the linkage mechanism 90 may be associated with the insert-type cutting device 70 by a linkage device. When in the insert-type cutting mode, the insert-type cutting device 70 may be connected to the housing 11, and the lower guard 123 may be pulled by the linkage mechanism 90 to accomplish the automatic opening of the lower guard 123. When in the push-type cutting mode, the insert-type cutting device 70 may be disconnected from the housing 11, such that the linkage mechanism 90 doesn't act on the lower guard 123, so the lower guard cannot be opened automatically.

Referring to FIG. 13, distinguishing the structure of the primary handle 19 of the power tool 10 from the above embodiments, the primary handle 19′ comprises a first handling portion 191 and a second handling portion 192. The user may select different handling portions according to different cutting modes so as to make the operation more comfortable. Certainly, persons skilled in the art may also envisage that a rotatable handle may be arranged on the housing. Thus users may select to set the handle in different positions as needed for implementing the cutting operation.

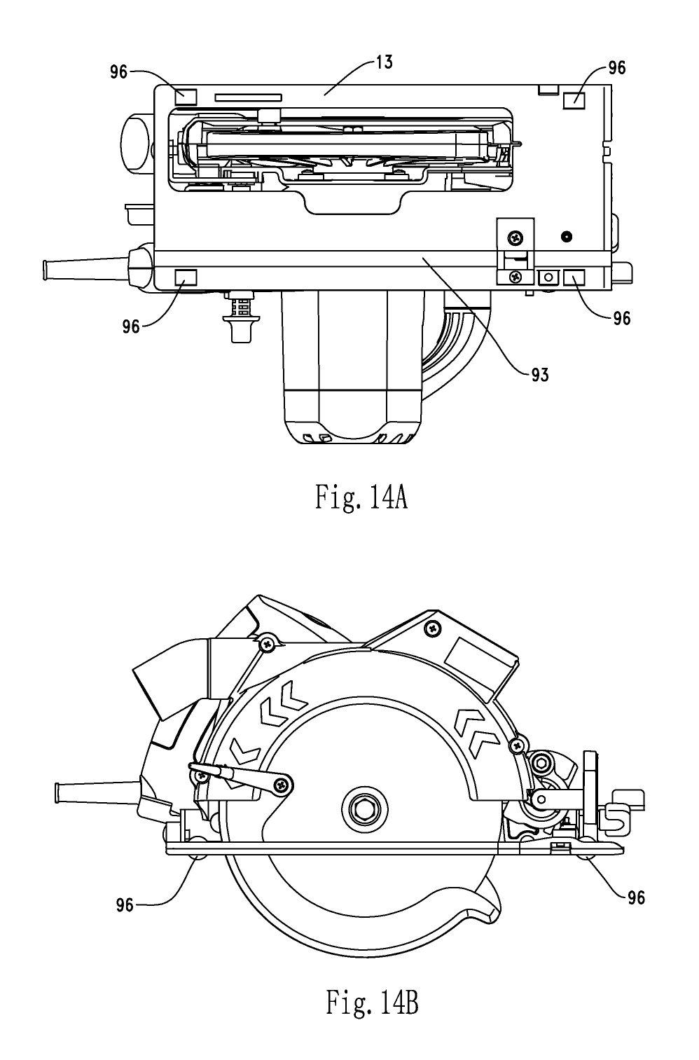

Referring to FIGS. 14A-B, a guide groove 95 may be added on the base plate 13 of the power tool 10 in the above embodiments. The cutting straightness of the power tool will be advantageously enhanced by the cooperation of the guide groove 95 and the guiding device. Persons skilled in the art may also envisage that a pulley device 96 may be added on the base plate 13 so as to facilitate the pushing forward of the power tool 10 in the insert-type cutting mode.

The embodiments described above are only explanatory for the concepts and principles of the invention without limitation to the contents of the invention. Various changes and modifications of the embodiments that should be considered within the scope of the present application will occur to a person skilled in the art.

What is claimed is:

1. A power tool comprising:
a housing,
a motor in the housing,
a circular saw blade driven to rotate by the motor and having a rotation axis, and
a base plate that supports the housing and contacts the surface of the workpiece to be cut,
wherein the housing is connected pivotably to the base plate around a pivotal axis that is parallel to the rotation axis, and the base plate has an elongated slot to allow the circular saw blade to protrude below the base plate and a first depth adjustment mechanism for adjusting the distance that the circular saw blade protrudes below the base plate,
the first depth adjustment mechanism comprising a depth guide member connected to the base plate and having a first elongated track thereon, and a clamp member for fixing the housing at a predetermined position with regard to the base plate, wherein the power tool also comprises an insert-type device that enables the circular saw blade to cut vertically.

2. The power tool according to claim 1, wherein the insert-type device is mounted on one of the base plate and the housing.

3. The power tool according to claim 1, wherein the power tool also comprises a clutch device.

4. The power tool according to claim 3, wherein the clutch device has a first clutch member and a second clutch member that mate with each other.

5. The power tool according to claim 4, wherein the first clutch member is arranged on one of the base plate and the housing, and the second clutch member is arranged on the insert-type device.

6. The power tool according to claim 4, wherein the power tool also comprises a locking device for locking the first clutch member and the second clutch member fixedly together when the first clutch member is aligned with the second clutch member.

7. The power tool according to claim 4, wherein the power tool also comprises an elastic member arranged between the second clutch member and the insert-type device.

8. The power tool according to claim 1, wherein the power tool also comprises a second depth adjustment mechanism that may adjust the area of the vertical cutting of the circular saw blade.

9. The power tool according to claim 8, wherein the second depth adjustment mechanism comprises a second track arranged on the depth guide member, a backstop member slidable in the second track, and an operating handle for operation by a user to fix the backstop member into the second track.

10. The power tool according to claim 9, wherein the first track and the second track have a common center.

11. A power tool comprising:
a housing,
a motor in the housing,
a circular saw blade driven to rotate by the motor and having a rotation axis, and
a base plate that supports the housing and contacts the surface of the workpiece to be cut,
wherein the housing is connected pivotably to the base plate around a pivotal axis that is parallel to the rotation axis, and the base plate has an elongated slot for the circular saw blade protruding to below the base plate,
wherein the power tool has a first cutting mode that may implement the cutting in the predetermined depth and a second cutting mode that may implement the vertical cutting in a limited area, as well as an insert-type device that enables the circular saw blade to cut vertically, the insert-type device having an elastic member, wherein the elastic force of the elastic member is only present when the power tool is in the second cutting mode.

12. The power tool according to claim 11, wherein the power tool also comprises a movable guard which may be opened automatically under the action of the linkage mechanism when the power tool is in the second cutting mode.

13. The power tool according to claim 11, wherein the power tool also comprises a switching device for switching between the first cutting mode and the second cutting mode.

14. The power tool according to claim 13, wherein the switching device is a clutch device.

15. A power tool comprising:
a housing,
a motor in the housing,
a circular saw blade driven to rotate by the motor and having a rotation axis, and
a base plate that supports the housing and works on the surface of the workpiece to be cut,
wherein the housing is connected pivotably to the base plate around a pivotal axis that is parallel to the rotation axis, and the base plate has an elongated slot for the circular saw blade protruding to below the base plate, a first depth adjustment mechanism for adjusting the distance that the circular saw blade protrudes below the base plate, a second depth adjustment mechanism for adjusting the area of the vertical cutting of the circular saw blade, and a depth guide member connected to the base plate and having at least one track thereon,
wherein the power tool also comprises an insert-type device that enables the circular saw blade to cut vertically and an elastic member.

16. The power tool according to claim 15, wherein the insert-type device is mounted on one of the base plate and the housing.

17. The power tool according to claim 15, wherein the power tool also comprises a clutch device.

18. The power tool according to claim 17, wherein the clutch device has a first clutch member and a second clutch member that mate with each other.

19. The power tool according to claim 18, wherein the first clutch member is arranged on one of the base plate and the housing, and the second clutch member is arranged on the insert-type device.

20. The power tool according to claim 19, wherein the power tool also comprises a locking device that locks the first clutch member and the second clutch member fixedly together when the first clutch member is aligned with the second clutch member.

21. The power tool according to claim 20, wherein the elastic member is arranged between the second clutch member and the insert-type device.

22. The power tool according to anyone of claims 15, wherein the depth guide device has a first track and a second track.

23. The power tool according to claim 22, wherein the second depth adjustment mechanism also has a backstop member slidable in the second track and an operating handle for operation by a user to fix the backstop member into the second track.

24. The power tool according to claim 23, wherein the first track and the second track have a common center.
